(19) United States
(12) Patent Application Publication
(10) Pub. No.: US 2015/0095751 A1
(43) Pub. Date: Apr. 2, 2015

(54) EMPLOYING PAGE LINKS TO MERGE PAGES OF ARTICLES

(71) Applicant: Microsoft Corporation, Redmond, WA (US)

(72) Inventors: Zhicheng Dou, Beijing (CN); Ruihua Song, Beijing (CN); Guangping Gao, Beijing (CN); Qian Zhang, Issaquah, WA (US); Ming Liu, Bellevue, WA (US); Raman Narayanan, Seattle, WA (US); Shelley Summer Gu, Seattle, WA (US); Yanti Aruswati Gouw, Bellevue, WA (US)

(73) Assignee: Microsoft Corporation, Redmond, WA (US)

(21) Appl. No.: 14/040,544

(22) Filed: Sep. 27, 2013

(51) Int. Cl. G06F 17/22

(52) U.S. Cl. CPC G06F 17/2235
USPC 715/205

(57) ABSTRACT

A content application employs page links to merge pages of articles. The content application retrieves an initial page of an article. An article such as a web article spread into multiple pages is retrieved for analysis. A page link of a following page of the article is detected within the initial page. The page link is a top choice among candidates sorted based on a weight score. The following page is retrieved using the page link and appended into the initial page to form an aggregate article. The aggregate article is presented for consumption.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications render visual effects through a display and enable users to provide input associated with the applications' operations.

Recently, devices of limited display size have penetrated the customer markets successfully. In some instances, limited purpose devices such as tablets have replaced multipurpose devices such as laptops for use in media consumption. Another consumer consumption pattern shifting towards limited purpose devices includes consumption of articles spread into multiple pages. Presenters spread articles to multiple pages to resemble paper productions and to generate additional advertisement revenue. Such articles provide a familiar format to the user. In addition, added features such as altering font type attributes improve on user interactivity compared to traditional sources of media such as paper productions. However, applications presenting articles are unable to re-assemble the contents of the articles to match the display size limitations of devices presenting the documents. Display size limitations may inconvenience users by displaying small portions of the articles and forcing users to scroll endlessly to reach desired content. Extensive scroll action involving multiple user actions may inhibit consumption flow and diminish user experience while consuming an article.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to employing page links to merge pages of articles. According to some embodiments, a content application may retrieve an initial page of an article. The article may be a web article spread over multiple web pages. The application may detect a page link for a following page of the article within the initial page. The page link may be hypertext markup language (HTML) based hyperlink providing an address for the following page.

Next, the following page may be retrieved using the page link. The following page may be accessed through the address stored within the page link. In addition, the following page and the initial page may be appended into an aggregate article. The aggregate article may be presented for consumption.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example concept diagram of employing page links to merge pages of articles according to some embodiments;

FIG. 2 illustrates an example of detecting page links within an initial page of an article according to embodiments;

FIG. 3 illustrates an example of detecting page links within a following page of the article according to embodiments;

FIG. 4 illustrates an example of merging the initial page and the following page of the article according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process employing page links to merge pages of articles according to embodiments.

### DETAILED DESCRIPTION

As briefly described above, page links may be employed to merge pages of articles. A content application may retrieve an initial page of an article and detect a link of a following page of the article within the initial page. The following page may be retrieved using the link and the initial page and the following page may be appended into an aggregate article. The aggregate article may be presented for consumption.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for employing page links to merge pages of articles. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

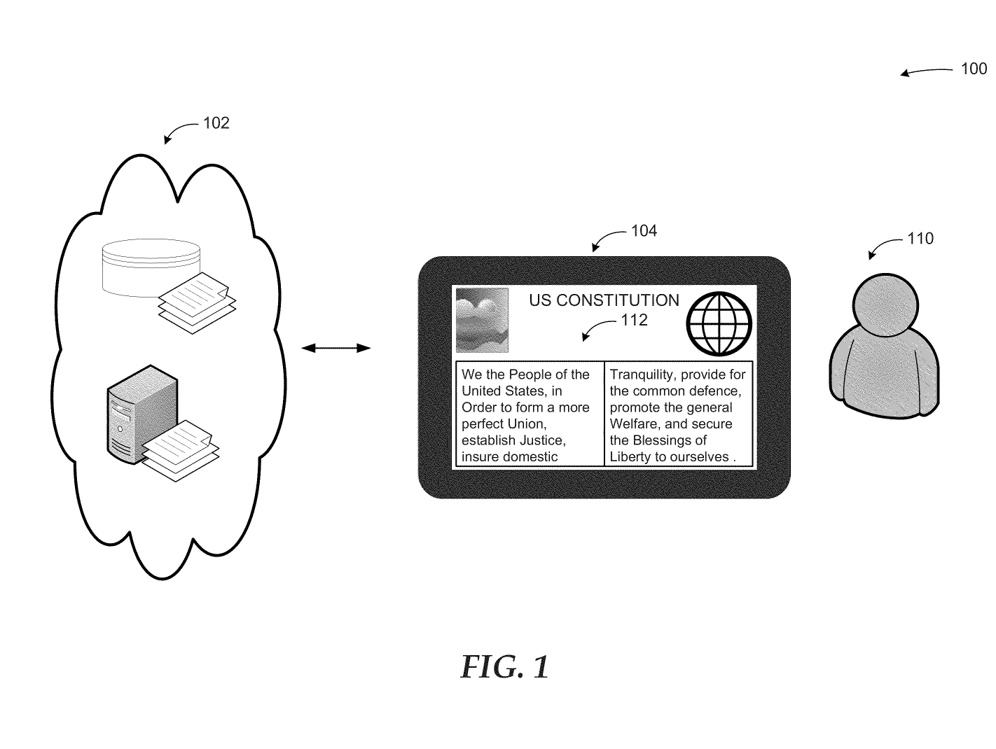

FIG. 1 illustrates an example concept diagram of employing page links to merge pages of articles according to some embodiments. The components and environments shown in diagram 100 are for illustration purposes. Embodiments may be implemented in various local, networked, cloud-based and similar computing environments employing a variety of computing devices and systems, hardware and software.

A device 104 may display an initial page 112 of an article through a content application as a result of an action by user 110. The article may be spread into multiple pages which may be accessed through controls called page links. The article may be presented as web pages through a standardized format such as hypertext markup language (HTML). Page links may include a hyperlink or a page control. In response to activation, an operation associated with the page control may be executed to display the following page. In addition, the page links may include an address of a following page.

The device 104 may communicate with external resources such as a cloud-hosted platform 102 to present the initial page 112. In an example scenario, the device 104 may retrieve the initial page 112 and the following page from the external resources. The cloud-hosted platform 102 may include remote resources such as data stores and content servers. The initial page 112 may be part of an article spread into multiple pages. The initial page 112 may be analyzed to determine page links associated with a following page.

Embodiments are not limited to implementation in a device 104 such as a tablet. The content application, according to embodiments, may be a local application executed in any device capable of displaying the application. Alternatively, the content application may be a hosted application such as a web service which may execute in a server while displaying application content through a client user interface such as a web browser. In addition to a touch-enabled device 104, interactions with the initial page 112 may be accomplished through other input mechanisms such as an optical gesture capture, a gyroscopic input device, a mouse, a keyboard, an eye-tracking input, and comparable software and/or hardware based technologies.

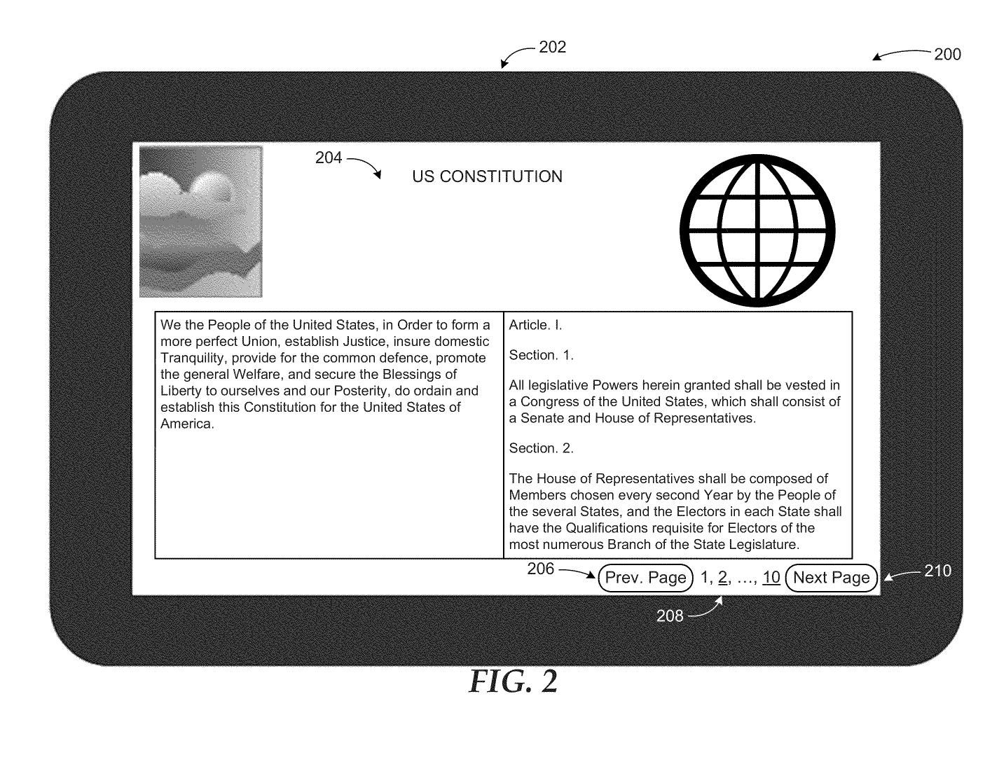

FIG. 2 illustrates an example of detecting page links within an initial page of an article according to embodiments. Diagram 200 displays the content application within a device 202 such as a tablet. The content application may display an initial page of an article including a page link to a following page.

The content application may analyze the initial page 204 to detect page links within the initial page 204. The initial page 204 may be formatted using a standardized format such as HTML. The content application may parse the HTML source of the initial page 204 to determine a list of candidate page links. The page links may be found in a hyperlink or a page control. The list of candidate page links may be generated from the detected page links including previous page control 206, hyperlink 208, and next page control 210. An address may be extracted from each candidate page link. The address may be detected to have a standardized format including a uniform resource locator (URL) formatted address. One or more of the addresses associated with the candidate page links may be associated with the following page.

According to some embodiments, the content application may remove non-matching page links from the list of candidates. The application may determine non-matching page links by finding an address in the page link referring to a resource external to a resource hosting the article. An example may include a page link having a URL address of an external web-site.

The content application may also evaluate the size of the address of the page link to compare against a predetermined size threshold. In response to determining the address of the page link exceeding the predetermined size threshold, the associated page link may be determined to be a non-matching page link. In addition, a page link having an address of the initial page 204 is determined to be a non-matching page link. Furthermore, any page link determine to have hidden elements are determined to be non-matching page links. Example of a hidden element may include an HTML instruction such as “display:none”, “display:hidden”, and similar ones.

According to other embodiments, the content application may parse a page identification (PageId) from the page link. The PageId may be a number such as a page number. Alternatively, the PageId may encompass the page number. In response to determining the PageId of the page link having a number that is an increment of a PageId of the initial page 204, the content application may determine the page link to be associated with a following page.

According to yet other embodiments, the content application may group candidate page links together. Multiple page links having a matching address may be treated as referring to one of the pages of the article. Furthermore a weight algorithm may be applied to each candidate page link to allocate a weight score in association with a following page. Each candidate page link may be sorted based on the weight score. A candidate page link with a weight score higher than other candidate page links may be determined to be associated with the following page. The top candidate page link may be selected as the page link referring to the following page. The top candidate page link may be used to retrieve the following page. The following page may be appended to the initial page 204 to form an aggregate article for presentation.

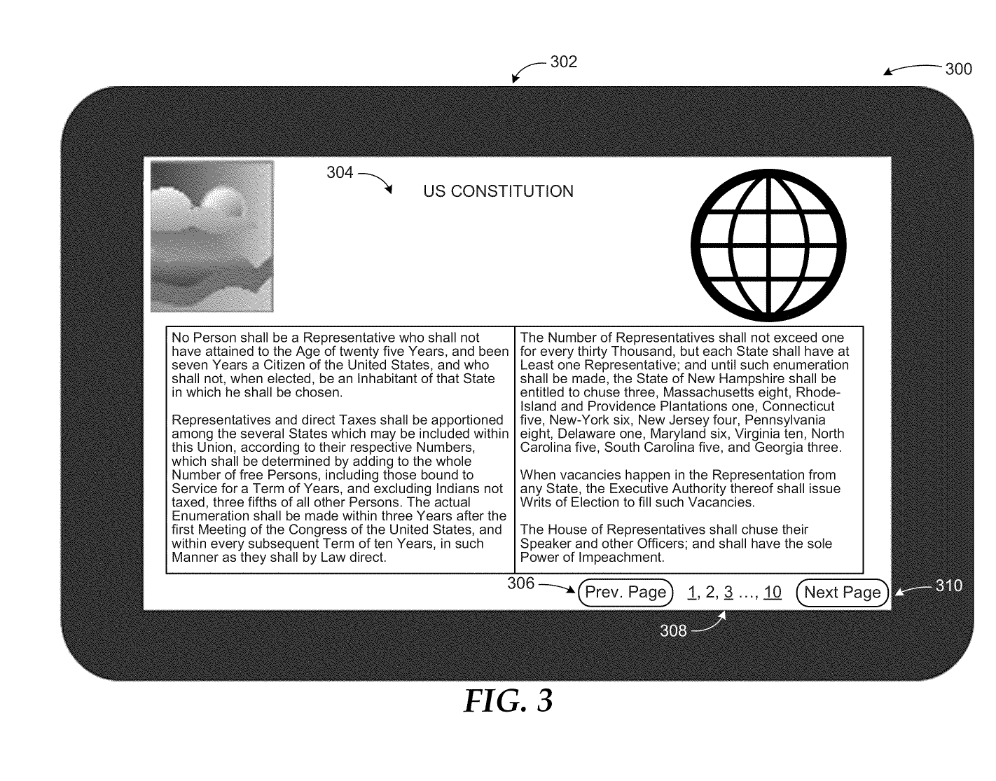

FIG. 3 illustrates an example of detecting page links within a following page of the article according to embodiments according to embodiments. Diagram 300 displays a device 302 displaying a following page through a content application.

According to some embodiments, a following page may be a next page or a previous page associated with an initial page of the article displayed by the content application. The content application may provide previous page control 306 and next page control 310 to execute an operation associated subsequent following pages. In response to activation of the previous page control 306, the application may display the initial page.

Alternatively, the application may display the subsequent following page in response to activation of the next page control 310 or the hyperlink 308. The previous page control 306, hyperlink 308, and next page control 310 may include an address such as a URL address referring to a page of the article associated with the page control or the hyperlink.

The content application may apply a weight algorithm to candidate page links. The weight algorithm may have two steps. The first step may involve determining following page terms within the address including “next,” “nextpage,” and similar ones. A page link including following page terms may be assigned an increased weight score compared to other page links lacking the term. The second step may include analyzing the page link for a PageId. A page link including a PageId may be scored with a high weight score compared to other page links lacking the PageId.

A weight score based on a following page term and a weight score based on a PageId may be added to determine a total weight score for the page link. Each candidate page link may be sorted based on their respective total weight scores. A candidate page link at a top position of the sorted list may be chosen as a page link for a subsequent following page associated with the following page 304 presented on device 302.

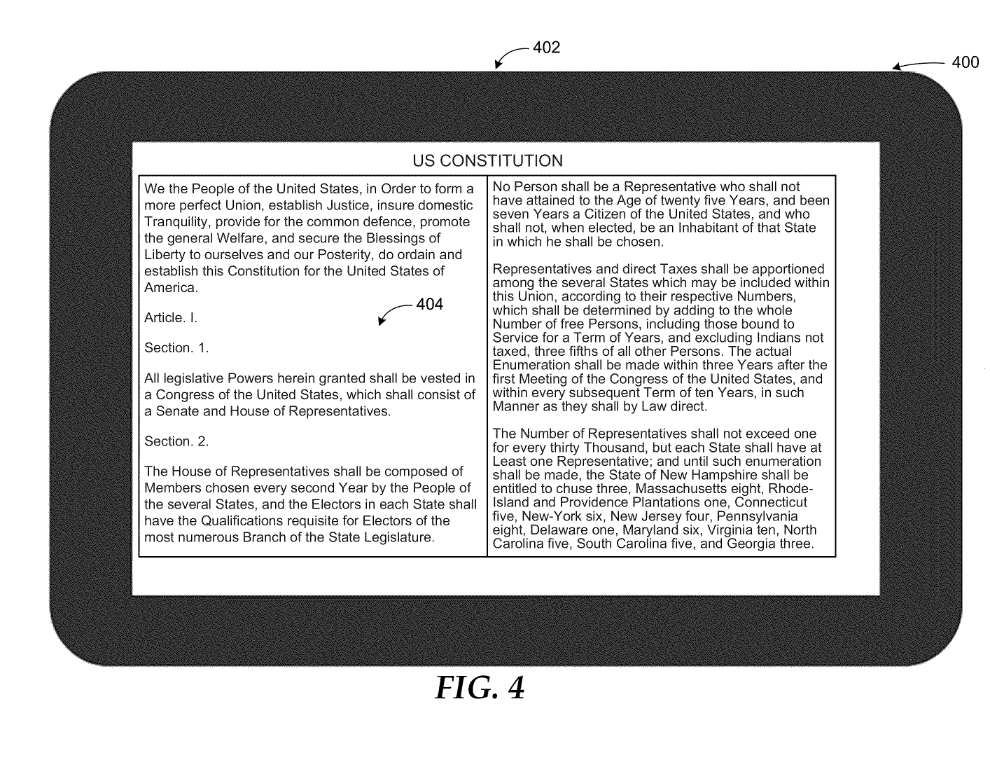

FIG. 4 illustrates an example of merging the initial page and the following page of the article according to embodiments. Diagram 400 displays a device 402 presenting an aggregate article.

A content application may retrieve the initial page 204 and the following page 304 and append their content to form the aggregate article 404. The content application may filter the initial page 204 and the following page 304 to remove non-core elements including advertisements, graphics, images, navigation controls, and similar ones prior to appending the initial page 204 and the following page 304. The content application may determine body sections of the initial page 204 and following page 304 through body tags encompassing the body section of the pages. The body tags may be formatted using a standardized format such as HTML.

The text of the body section of the following page 304 may be appended to the text of the body section of the initial page 204 to form the aggregate article 404. The aggregate article 404 may be presented by the content application on device 402. Scroll bars may be provided to navigate the aggregate article. Additionally, font attributes of the aggregate article may be changed to fit the aggregate article within a screen size of the device 402. Alternatively, the initial page 204 may be appended to following page 304 absent any modification or filtering. The resulting aggregate article may be displayed on device 402 by the content application.

The example scenarios and schemas in FIG. 2 through 4 are shown with specific components, data types, and configurations. Embodiments are not limited to systems according to these example configurations. Employing page links to merge pages of articles may be implemented in configurations employing fewer or additional components in applications and user interfaces. Furthermore, the example schema and components shown in FIG. 2 through 4 and their subcomponents may be implemented in a similar manner with other values using the principles described herein.

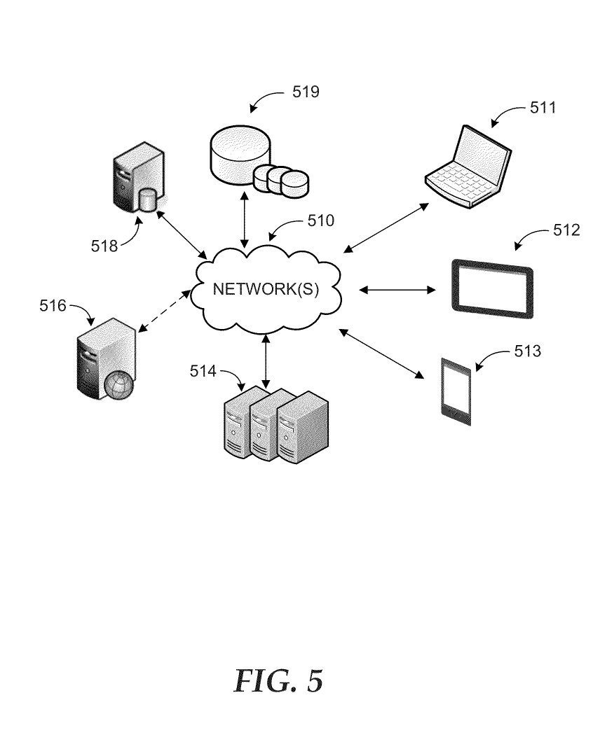

FIG. 5 is a networked environment, where a system according to embodiments may be implemented. Local and remote resources may be provided by one or more servers 514 or a single server (e.g. web server) 516 such as a hosted service. An application may execute on individual computing devices such as a smart phone 513, a tablet device 512, or a laptop computer 511 (‘client devices’) and retrieve a page of an article intended for display through network(s) 510.

As discussed above, page links may be employed to merge pages of articles. A content application may retrieve an initial page of an article and detect a page link of a following page of the article within the initial page. The following page may be retrieved using the page link. The initial page and the following page may be appended into an aggregate article for presentation. Client devices 511-513 may enable access to applications executed on remote server(s) (e.g. one of servers 514) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data resources, and data distribution systems may be used to employ page links to merge pages of articles. Furthermore, the networked environments discussed in FIG. 5 are for illustration purposes only. Embodiments are not limited to the example applications, modules, or processes.

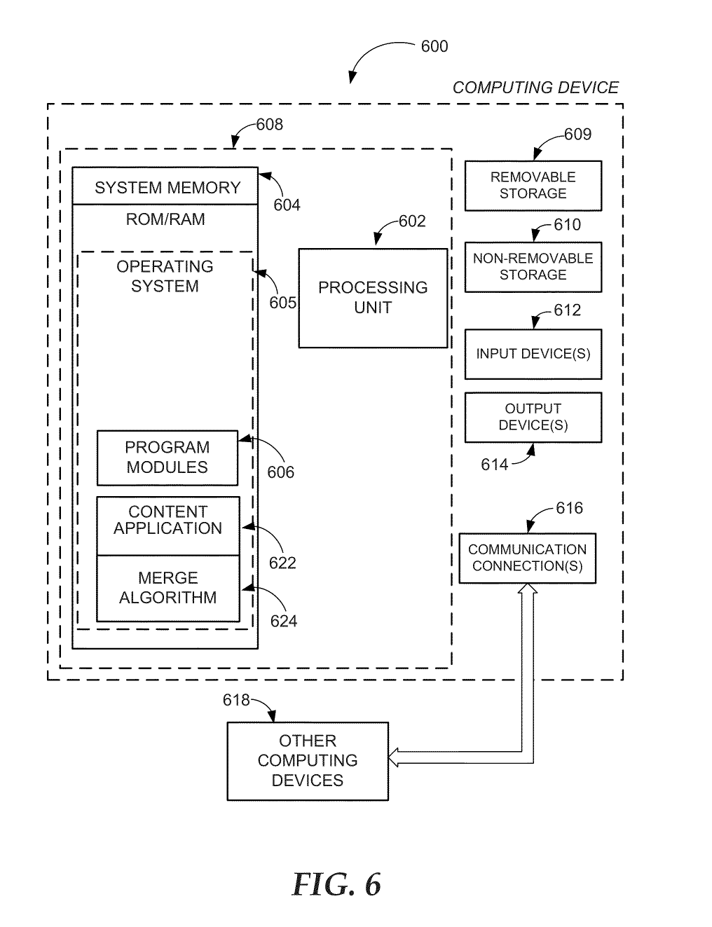

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS® and WINDOWS PHONE® operating systems from MICROSOFT CORPORATION of Redmond, Wash. The system memory 604 may also include one or more software applications such as program modules 606, a content application 622, and a merge algorithm 624.

A content application 622 may retrieve an initial page of an article. The content application 622 may detect a page link of a following page of the article within the initial page. The content application may retrieve the following page using the page link and the merge algorithm 624 may append the initial page and the following page to form an aggregate article. The content application 622 may present the aggregate article in a screen of the device 600, in proximity. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

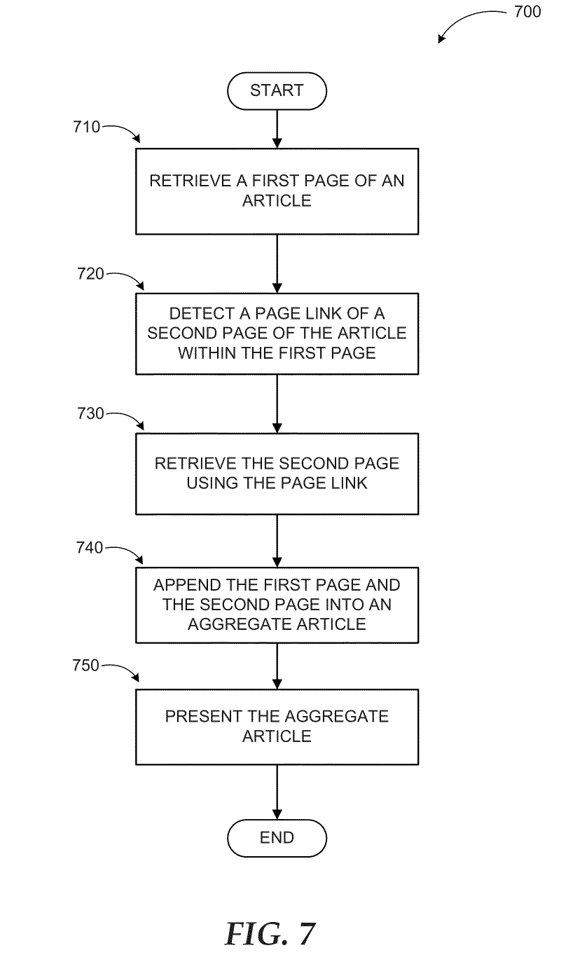

FIG. 7 illustrates a logic flow diagram for a process employing page links to merge pages of articles according to embodiments. Process 700 may be implemented by a content application, in some examples.

Process 700 may begin with operation 710 where the content application may retrieve a first page of an article. The article may be in a standardized format such as HTML and may be spread into multiple pages. At operation 720, a page link of a second page of the article may be detected within the first page. The page link may include a hyperlink or a page control. The hyperlink and the page control may include an address element referring to a location of the second page.

Next, the second page may be retrieved using the page link, at operation 730. A resource may be queries using a location of the page to find the second page. The second page may be retrieved in response to a positive determination of locating the second page. In addition, the first page and the second page may be appended into an aggregate article, at operation 740. The content application may remove non-core elements from the aggregate article including an advertising, an annotation, a navigation control, and similar ones. The aggregate article may be presented at operation 750.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Employing page links to merge pages of articles, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for employing page links to merge pages of articles, the method comprising:
retrieving a first page of an article;
detecting a page link of a second page of the article within the first page;
retrieving the second page using the page link;
appending the first page and the second page into an aggregate article; and
displaying the aggregate article.

2. The method of claim 1, further comprising:
finding the page link in at least one of: a hyperlink and a page control.

3. The method of claim 1, further comprising:
determining the page link from a list of candidate page links extracted from the first page; and
extracting an address from a first link from the candidate page links.

4. The method of claim 3, further comprising:
determining the address to refer to an external resource; and
removing the first link from the list.

5. The method of claim 3, further comprising:
evaluating a size of the address by comparing the size against a predetermined size threshold; and
removing the first link from the list in response to determining the size of the address exceed the predetermined size threshold.

6. The method of claim 3, further comprising:
determining the address to include a hidden element; and
removing the first link from the list.

7. The method of claim 3, further comprising:
determining a first page identification (PageId) within the first page; and
parsing a first number from the first PageId corresponding to a page number of the first page.

8. The method of claim 7, further comprising:
detecting a second PageId in the first link;
parsing a second number from the second PageId corresponding to another page number;
determining the second number being an increment of the first number; and
assigning the first link as the page link.

9. The method of claim 3, further comprising:
detecting the address to have a standardized format including a uniform resource locator (URL) formatted address.

10. The method of claim 3, further comprising:
determining the address to refer to a location of another page associated with the first link.

11. The method of claim 10, further comprising:
extracting another address of a second link from the candidate page links;
determining the address and the other address to match; and
grouping the first link and the second link together in the list.

12. A computing device for employing page links to merge pages of articles, the computing device comprising:
a memory configured to store instructions; and
a processor coupled to the memory, the processor executing a content application in conjunction with the instructions stored in the memory, wherein the application is configured to:
retrieve a first page of an article;
detect a page link of a second page of the article within the first page in at least one of: a hyperlink and a page control;
retrieve the second page using the page link;
append the first page and the second page into an aggregate article; and
display the aggregate article.

13. The computing device of claim 12, wherein the application is further configured to:
determine the page link from a list of candidate page links extracted from the first page; and
apply a weight score to a first link from the candidate page links.

14. The computing device of claim 13, wherein the application is further configured to:
extract an address from the first link;
determine a following page term within the address including at least one of: “next” and “next page;” and
assign another weight score to the first link that is higher than a weight score assigned to a second link from the candidate page links lacking a following page term.

15. The computing device of claim 13, wherein the application is further configured to:
analyze the first link for a page identification (PageId); and
assign another weight score to the first link that is higher than a weight score assigned to a second link from the candidate page links lacking a PageId.

16. The computing device of claim 15, wherein the application is further configured to:
add the weight scores of the first and second links to compute a total weight score; and
sort the first link within the list based on the weight score assigned to the first link and the total weight score.

17. The computing device of claim 16, wherein the application is further configured to:
assign a top candidate page link from the list as the page link.

18. A computer-readable memory device with instructions stored thereon for employing page links to merge pages of articles, the instructions comprising:
retrieving a first page of an article;
detecting a page link of a second page of the article within the first page in at least one of: a hyperlink and a page control;
determining the page link from a list of candidate page links extracted from the first page;
applying a weight score to each of the candidate page links to sort the candidate page links within the list;
assigning a top candidate page link from the list as the page link;
retrieving the second page using the page link;
appending the first page and the second page into an aggregate article; and
displaying the aggregate article.

19. The computer-readable memory device of claim 18, wherein the instructions further comprise:
extracting a title from the first page;
extracting a first main content for the first page from the rendered page;
extracting a second main content for a next page based a retrieval command is the second main content is different from the first main content; and
appending the title, the first main content, and the second main content to form the aggregate article.

20. The computer-readable memory device of claim 18, wherein the instructions further comprise:
filtering the first page and the second page to remove non-core elements including at least one of: an advertisement, a graphic, an image, and a navigation control prior to appending the first page and the second page.
